(19) United States
(12) Patent Application Publication
(10) Pub. No.: US 2026/0296057 A1
(43) Pub. Date: Oct. 1, 2026

(54) PRINTING DEVICE AND PRINTING METHOD

(71) Applicant: SEIKO EPSON CORPORATION, Tokyo (JP)

(72) Inventors: Kazuhisa KATO, MATSUMOTO-SHI (JP); Takanori KAWAI, INA-SHI (JP)

(21) Appl. No.: 19/577,688

(22) Filed: Mar. 25, 2026

(30) Foreign Application Priority Data
Mar. 25, 2025 (JP) 2025-049352

(51) Int. Cl. B41J 11/00; B41J 11/42; B41J 15/04

(52) U.S. Cl. CPC B41J 11/0005; B41J 11/009; B41J 11/42; B41J 15/048

(57) ABSTRACT

According to an aspect of the present disclosure, there is provided a printing device including a conveyance section, a printing section, a wrapping section on which a medium can be wound, and a de-curl roller pair capable of performing a de-curl operation of nipping a curled portion caused in the medium when the medium is wound on the wrapping section and bending the curled portion in a correcting direction. The de-curl operation is an operation carried out when the conveyance is stopped for a first predetermined time or more in a state in which the medium is wound on the wrapping section. The control section conveys the medium until the curled portion reaches the de-curl roller pair and conveys the medium toward the printing section after stopping the conveyance for a second predetermined time in a state in which the curled portion is nipped by the de-curl roller pair.

The present application is based on, and claims priority from JP Application Serial Number 2025-049352, filed Mar. 25, 2025, the disclosure of which is hereby incorporated by reference herein in its entirety.

### BACKGROUND

### 1. Technical Field

The present disclosure relates to a printing device and a printing method.

### 2. Related Art

Various printing devices have been used. Among these printing devices, there is a printing device that conveys a medium and performs printing on the conveyed medium. In the printing device having the configuration described above, in some case, the medium is curled and conveyed in a conveyance path for the medium and a curl occurs in the medium. For example, JP-A-2016-135694 describes that, when a printing device is turned off, a portion of a medium located at a bent portion of a conveyance path has a curved crease. Therefore, the printing device described in JP-A-2016-135694 includes a heater section provided near a discharge port and a de-curl section provided near an inlet of a conveyance path. When the medium has a curved crease, in order to eliminate the curved crease, it is possible to cause a portion having the curved crease to reach a heater section further downstream than a printing section in a conveyance direction, after heating the portion having curved crease with the heater section, reversely convey the portion having curved crease until the portion having curved crease reaches the de-curl section and nip the portion having curved crease for a predetermined time with a roller pair to de-curl the portion having curved crease.

JP-A-2016-135694 is an example of the related art.

However, in the printing device described in JP-A-2016-135694, it is necessary to once convey the portion having curved crease to the heater section and return the portion to the de-curl position again, which takes time. Since the medium in a state of having the portion having curved crease has to be conveyed to the heater section, the portion having curved crease is likely to cause a jam in a conveyance path to the heater section. Since the heater section is provided near the discharge port, a user is likely to touch the medium once protruding from the discharge port and cause a conveyance failure or the like. Furthermore, in the printing device described in JP-A-2016-135694, a sequence for de-curling is carried out every time the printing device is turned on. However, when a period from when the printing device is turned off once until when the printing device is turned on next is short, a portion located in the bent portion sometimes does not have a very strong curved crease. In such a case, when the sequence for de-curling is carried out when the printing device is turned on again, the medium is likely to have a new curved crease curling in the opposite direction. As explained above, in the printing device of the related art, it is difficult to suitably de-curl a curled portion that has occurred in the medium.

### SUMMARY

According to an aspect of the present disclosure, there is provided a printing device including: a conveyance section configured to convey a medium in a conveyance direction along a conveyance path; a printing section configured to eject droplets onto the medium to perform printing; a wrapping section provided on the conveyance path, the medium being wound on the wrapping section; a de-curl roller pair located further downstream than the wrapping section in the conveyance direction and configured to perform a de-curl operation of nipping a curled portion caused in the medium when the medium is wound on the wrapping section and bending the curled portion in a correcting direction; and a control section configured to control the de-curl operation to be executable and control the conveyance of the medium by the conveyance section, wherein the de-curl operation is an operation carried out when the conveyance is stopped for a first predetermined time or more in a state in which the medium is wound on the wrapping section, and the control section conveys the medium until the curled portion reaches the de-curl roller pair and conveys the medium toward the printing section after stopping the conveyance for a second predetermined time in a state in which the curled portion is nipped by the de-curl roller pair.

According to another aspect of the present disclosure, there is provided a printing method performed by a printing device including: a conveyance section configured to convey a medium in a conveyance direction along a conveyance path; a printing section configured to eject droplets onto the medium to perform printing; a wrapping section provided on the conveyance path, the medium being wound on the wrapping section; a de-curl roller pair located further downstream than the wrapping section in the conveyance direction and configured to perform a de-curl operation of nipping a curled portion caused in the medium when the medium is wound on the wrapping section and bending the curled portion in a correcting direction, the de-curl operation being an operation carried out when the conveyance is stopped for a first predetermined time or more in a state in which the medium is wound on the wrapping section, the printing method including: conveying the medium until the curled portion reaches the de-curl roller pair; and conveying the medium toward the printing section after stopping the conveyance for a second predetermined time in a state in which the curled portion is nipped by the de-curl roller pair.

### BRIEF DESCRIPTION OF THE DRAWINGS

FIG. 1 is a side cross-sectional view illustrating an internal configuration of a printing device according to an embodiment of the present disclosure.

FIG. 2 is a side cross-sectional view illustrating the periphery of a wrapping section and a de-curl roller pair of the printing device illustrated in FIG. 1 and is a diagram illustrating a mechanism of a curled portion occurring in a medium.

FIG. 3 is a side cross-sectional view illustrating the periphery of the wrapping section and the de-curl roller pair of the printing device illustrated in FIG. 1 and is a diagram illustrating a mechanism of correcting and eliminating the curled portion that has occurred in the medium.

FIG. 4 is a flowchart illustrating an example of a printing method by the printing device illustrated in FIG. 1.

### DESCRIPTION OF EMBODIMENTS

First, the present disclosure is schematically explained.

According to a first aspect of the present disclosure, there is provided a printing device including: a conveyance section configured to convey a medium in a conveyance direction along a conveyance path; a printing section configured to eject droplets onto the medium to perform printing; a wrapping section provided on the conveyance path, the medium being wound on the wrapping section; a de-curl roller pair located further downstream than the wrapping section in the conveyance direction and configured to perform a de-curl operation of nipping a curled portion caused in the medium when the medium is wound on the wrapping section and bending the curled portion in a correcting direction; and a control section configured to control the de-curl operation to be executable and control the conveyance of the medium by the conveyance section, wherein the de-curl operation is an operation carried out when the conveyance is stopped for a first predetermined time or more in a state in which the medium is wound on the wrapping section, and the control section conveys the medium until the curled portion reaches the de-curl roller pair and conveys the medium toward the printing section after stopping the conveyance for a second predetermined time in a state in which the curled portion is nipped by the de-curl roller pair.

According to this aspect, the de-curl operation is the operation carried out when the conveyance is stopped for the first predetermined time or more in the state in which the medium is wound on the wrapping section, the medium is conveyed until the curled portion reaches the de-curl roller pair and the medium is conveyed toward the printing section after the conveyance is stopped for the second predetermined time in the state in which the curled portion is nipped by the de-curl roller pair. By performing the de-curl operation explained above, it is possible to reduce a conveyance amount of the medium involved in the de-curl operation and it is possible to carry out the de-curl operation in a short time. By appropriately setting the first predetermined time and the second predetermined time, it is possible to correct a curved crease while preventing a new curved crease curling in the opposite direction in the curled portion from occurring. That is, it is possible to suitably de-curl the curled portion that has occurred in the medium.

A printing device according to a second aspect of the present disclosure is an aspect dependent from the first aspect, wherein, every time the conveyance of the medium is stopped, the control section counts an elapsed time after the conveyance of the medium was stopped, when the medium was conveyed after the elapsed time exceeded the first predetermined time, carries out the de-curl operation at a time of conveyance performed after the first predetermined time elapsed, and, when the medium was conveyed before the elapsed time exceeds the first predetermined time, does not carry out the de-curl operation at the time of the conveyance and resets the elapsed time.

According to this aspect, the elapsed time is counted every time the conveyance of the medium is stopped, the de-curl operation is carried out when the medium was conveyed after the elapsed time exceeded the first predetermined time, and the de-curl operation is not carried out and the elapsed time is reset when the medium was conveyed before the elapsed time exceeds the first predetermined time. By performing the de-curl operation explained above, it is possible to suitably correct a curved crease while preventing a new curved crease curling in the opposite direction in the curled portion from occurring.

A printing device according to a third aspect of the present disclosure is an aspect dependent from the first or second aspect, wherein the first predetermined time and the second predetermined time are changed according to at least one of rigidity and thickness of the medium.

According to this aspect, the first predetermined time and the second predetermined time can be changed according to at least one of the rigidity and the thickness of the medium. By performing the de-curl operation explained above, it is possible to particularly suitably de-curl, according to at least one of the rigidity and the thickness of the medium, a curled portion that has occurred in the medium.

A printing device according to a fourth aspect of the present disclosure is an aspect dependent from any one of the first to third aspects, the first predetermined time and the second predetermined time are changed according to at least one of ambient temperature and ambient humidity.

According to this aspect, the first predetermined time and the second predetermined time can be changed according to at least one of the ambient temperature and the ambient humidity. By performing the de-curl operation explained above, it is possible to particularly suitably de-curl, according to at least one of the ambient temperature and the ambient humidity, a curled portion that has occurred in the medium.

A printing device according to a fifth aspect of the present disclosure is an aspect dependent from any one of the first to fourth aspects, wherein the second predetermined time is shorter than the first predetermined time.

According to this aspect, the second predetermined time is shorter than the first predetermined time. By performing the de-curl operation explained above, it is possible to reduce a time required for the de-curl and suitably correct a curved crease while preventing a new curved crease curling in the opposite direction in the curled portion from occurring.

A printing device according to a sixth aspect of the present disclosure is an aspect dependent from any one of the first to fifth aspects, wherein the second predetermined time is changed according to a time in which the conveyance is stopped in a state in which the medium is wound on the wrapping section.

According to this aspect, the second predetermined time can be changed according to the time in which the conveyance is stopped in the state in which the medium is wound on the wrapping section. By performing the de-curl operation explained above, it is possible to suitably correct a curved crease while preventing a new curved crease curling in the opposite direction in the curled portion from occurring.

A printing device according to a seventh aspect of the present disclosure is an aspect dependent from any one of the first to sixth aspects, wherein, when conveying the medium until the curled portion reaches the de-curl roller pair, the control section conveys the medium by a predetermined amount in the conveyance direction such that the curled portion passes through the de-curl roller pair in a state in which the de-curl roller pair nips the medium and conveys the medium in a reverse conveyance direction, which is a direction opposite to the conveyance direction, to a position where the curled portion is nipped by the de-curl roller pair and brings the curled portion into a state of being nipped by the de-curl roller pair.

According to this aspect, when conveying the medium until the curled portion reaches the de-curl roller pair, the control section conveys the medium by the predetermined amount in the conveyance direction such that the curled portion passes through the de-curl roller pair in the state in which the de-curl roller pair nips the medium and conveys the medium in the reverse conveyance direction to the position where the curled portion is nipped by the de-curl roller pair and brings the curled portion into the state of being nipped by the de-curl roller pair. That is, since the curled portion passes through the de-curl roller pair once, a curved crease is eased. For this reason, the second predetermined time can be reduced.

A printing method according to an eighth aspect of the present disclosure is a printing method performed by a printing device including: a conveyance section configured to convey a medium in a conveyance direction along a conveyance path; a printing section configured to eject droplets onto the medium to perform printing; a wrapping section provided on the conveyance path, the medium being wound on the wrapping section; and a de-curl roller pair located further downstream than the wrapping section in the conveyance direction and configured to perform a de-curl operation of nipping a curled portion caused in the medium when the medium is wound on the wrapping section and bending the curled portion in a correcting direction, the de-curl operation being an operation carried out when the conveyance is stopped for a first predetermined time or more in a state in which the medium is wound on the wrapping section, the printing method including: conveying the medium until the curled portion reaches the de-curl roller pair; and conveying the medium toward the printing section after stopping the conveyance for a second predetermined time in a state in which the curled portion is nipped by the de-curl roller pair.

According to this aspect, the elapsed time is counted every time the conveyance of the medium is stopped, the de-curl operation is carried out when the medium was conveyed after the elapsed time exceeded the first predetermined time, and the de-curl operation is not carried out and the elapsed time is reset when the medium was conveyed before the elapsed time exceeds the first predetermined time. By performing the de-curl operation explained above, it is possible to suitably correct a curved crease while preventing a new curved crease curling in the opposite direction in the curled portion from occurring.

A printing method according to a ninth aspect of the present disclosure is an aspect dependent from the eighth aspect, further including: every time the conveyance of the medium is stopped, counting an elapsed time after the conveyance of the medium was stopped; when the medium was conveyed after the elapsed time exceeded the first predetermined time, carrying out the de-curl operation at a time of conveyance performed after the first predetermined time elapsed; and, when the medium was conveyed before the elapsed time exceeds the first predetermined time, not carrying out the de-curl operation at the time of the conveyance and resetting the elapsed time.

According to this aspect, the elapsed time is counted every time the conveyance of the medium is stopped, the de-curl operation is carried out when the medium was conveyed after the elapsed time exceeded the first predetermined time, and the de-curl operation is not carried out and the elapsed time is reset when the medium was conveyed before the elapsed time exceeds the first predetermined time. By performing the de-curl operation explained above, it is possible to suitably correct a curved crease while preventing a new curved crease curling in the opposite direction in the curled portion from occurring.

A printing method according to a tenth aspect of the present disclosure is an aspect dependent from the eighth or ninth aspect, wherein the first predetermined time and the second predetermined time are changed according to at least one of rigidity and thickness of the medium.

According to this aspect, the first predetermined time and the second predetermined time can be changed according to at least one of the rigidity and the thickness of the medium. By performing the de-curl operation explained above, it is possible to particularly suitably de-curl, according to at least one of the rigidity and the thickness of the medium, a curled portion that has occurred in the medium.

A printing method according to an eleventh aspect of the present disclosure is an aspect dependent from any one of the eighth to tenth aspects, wherein the first predetermined time and the second predetermined time are changed according to at least one of ambient temperature and ambient humidity.

According to this aspect, the first predetermined time and the second predetermined time can be changed according to at least one of the ambient temperature and the ambient humidity. By performing the de-curl operation explained above, it is possible to particularly suitably de-curl, according to at least one of the ambient temperature and the ambient humidity, a curled portion that has occurred in the medium.

A printing method according to a twelfth aspect of the present disclosure is an aspect dependent from any one of the eighth to eleventh aspects, wherein the second predetermined time is shorter than the first predetermined time.

According to this aspect, the second predetermined time is shorter than the first predetermined time. By performing the de-curl operation explained above, it is possible to suitably correct a curved crease while preventing a new curved crease curling in the opposite direction in the curled portion from occurring.

A printing method according to a thirteenth aspect of the present disclosure is an aspect dependent from any one of the eighth to twelfth aspects, wherein the second predetermined time is changed according to a time in which the conveyance is stopped in a state in which the medium is wound on the wrapping section.

According to this aspect, the second predetermined time can be changed according to the time in which the conveyance is stopped in the state in which the medium is wound on the wrapping section. By performing the de-curl operation explained above, it is possible to suitably correct a curved crease while preventing a new curved crease curling in the opposite direction in the curled portion from occurring.

A printing method according to a fourteenth aspect of the present disclosure is an aspect dependent from any one of the eighth to thirteenth aspects, further including: when conveying the medium until the curled portion reaches the de-curl roller pair, conveying the medium by a predetermined amount in the conveyance direction such that the curled portion passes through the de-curl roller pair in a state in which the de-curl roller pair nips the medium; conveying the medium in a reverse conveyance direction, which is a direction opposite to the conveyance direction, to a position where the curled portion is nipped by the de-curl roller pair; and bringing the curled portion into a state of being nipped by the de-curl roller pair.

According to this aspect, when conveying the medium until the curled portion reaches the de-curl roller pair, the control section conveys the medium by the predetermined amount in the conveyance direction such that the curled portion passes through the de-curl roller pair in the state in which the de-curl roller pair nips the medium and conveys the medium in the reverse conveyance direction to the position where the curled portion is nipped by the de-curl roller pair and brings the curled portion into the state of being nipped by the de-curl roller pair. That is, since the curled portion passes through the de-curl roller pair once, a curved crease is eased. For this reason, the second predetermined time can be reduced.

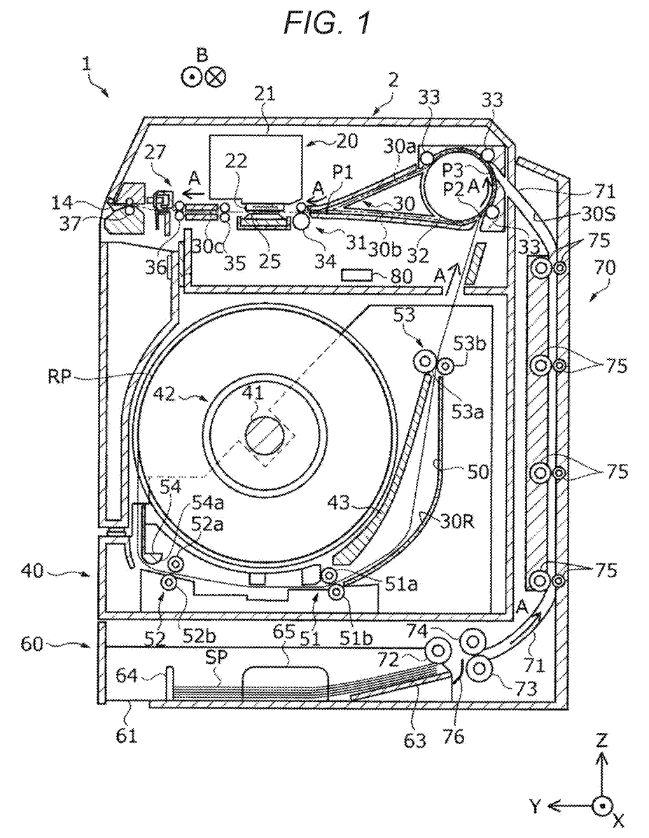

Hereinafter, an embodiment according to the present disclosure is specifically explained with reference to the drawings. First, an overview of a printing device 1 according to an embodiment of the present disclosure is explained with reference to FIG. 1. The printing device 1 is, for example, an inkjet printer that ejects ink onto a medium to perform printing. In a coordinate added to the drawings, assuming that the printing device 1 is placed on the horizontal plane, three virtual axes orthogonal to one another are represented as an X axis, a Y axis, and a Z axis. The Y axis is an axis parallel to the front-rear direction of the printing device 1 and a tip side of an arrow indicating the Y axis is represented as "front". The X axis is an axis parallel to the left-right direction of the printing device 1 and a tip side of an arrow indicating the X axis is represented as "right". The Z axis is a virtual axis parallel to the vertical direction and a tip side of an arrow indicating the Z axis is represented as "upper".

As illustrated in FIG. 1, the printing device 1 includes a housing 2. On the inside of the housing 2, a roll paper storing section 40 that stores roll paper RP, which is a medium, a single sheet paper storing section 60 that stores single sheet paper SP, which is a medium other than the roll paper RP, and a printing section 20 capable of performing printing on the roll paper RP supplied from the roll paper storing section 40 and capable of performing printing on the single sheet paper SP supplied from the single sheet paper storing section 60 are provided.

The printing section 20 includes a head 22 including nozzles that eject ink toward the medium and a carriage 21 on which the head 22 is mounted. The printing section 20 is configured to be capable of reciprocating the carriage 21 along the X axis. A support section 25 that supports the medium is provided at a position facing the head 22. The head 22 performs printing on the medium supported by the support section 25 by discharging ink while reciprocating in the width direction B together with the carriage 21. In the embodiment, a serial head type in which the head 22 reciprocates in the width direction is exemplified as the printing section 20. However, the printing section 20 may be a line head type printing section in which a head extends in the width direction and is fixedly arrayed.

A conveyance path 30 through which the medium is conveyed and a cutting section 27 capable of cutting the medium printed by the printing section 20 are provided on the inside of the housing 2. The conveyance path 30 includes a supply path 30a and a reverse path 30b provided further upstream than the support section 25 and a discharge path 30c provided further downstream than the support section 25. Furthermore, the supply path 30a includes a roll paper supply path 30R through which the roll paper RP, which is an example of the medium, is supplied and a single sheet paper supply path 30S through which the single sheet paper SP, which is an example of the medium, is supplied.

The supply path 30a is a path connecting the roll paper supply path 30R to the support section 25. A roll paper merging point P2 of merging with the roll paper supply path 30R is provided upstream of the supply path 30a. A branch point P1 of branching from the supply path 30a when the medium is conveyed from downstream to upstream is provided downstream of the supply path 30a. The reverse path 30b is a path connecting the branch point P1 to the roll paper merging point P2. A single sheet paper merging point P3 of merging with the single sheet paper supply path 30S is provided between the roll paper merging point P2 and the branch point P1 in the supply path 30a.

A discharge port 14 through which a printed medium is discharged is provided on the front surface of the housing 2. The discharge path 30c is a path connecting the support section 25 to the discharge port 14. A cutting section 27 that cuts the medium printed by the printing section 20 is provided halfway in the discharge path 30c.

In the conveyance path 30, a conveyance section 31 that conveys the medium supplied to the conveyance path 30 is provided. The conveyance section 31 includes an intermediate roller 32, a plurality of driven rollers 33 provided on the outer circumference of the intermediate roller 32, and an upstream conveyance roller pair 34 in order from upstream in the supply path 30a. The driven roller 33 is rotatably provided and is driven to rotate with the medium sandwiched between the driven roller 33 and the intermediate roller 32. The conveyance section 31 includes a downstream conveyance roller pair 35, a roller pair 36, and a roller pair 37 in order from upstream in the discharge path 30c. The roller pair 36 is located upstream of the cutting section 27 and the roller pair 37 is located downstream of the cutting section 27.

The intermediate roller 32, the driven roller 33, the upstream conveyance roller pair 34, the downstream conveyance roller pair 35, the roller pair 36, and the roller pair 37 convey the medium by rotating in a state of sandwiching the medium. The conveyance section 31 is driven to rotate forward, whereby the medium is conveyed from upstream to downstream in the conveyance direction A, that is, the forward direction. The conveyance section 31 is driven to reversely rotate, whereby the medium is conveyed from downstream to upstream in a direction opposite to the conveyance direction A, that is, the opposite direction.

The printing device 1 ejects the ink from the printing section 20 onto the medium located on the support section 25 while driving the conveyance section 31 to rotate forward and conveying the medium from upstream to downstream and performs printing on a first surface of the medium. The printing device 1 is configured to be capable of performing printing on a second surface that is a back surface of the first surface of the medium. The printing device 1 drives the conveyance section 31 to reversely rotate to convey, in the opposite direction, the medium after being printed on the first surface. The medium reaches upstream of the supply path 30a from the branch point P1 through the reverse path 30b. The printing device 1 drives the conveyance section 31 to rotate forward again and the medium makes full one turn around the outer circumference of the intermediate roller 32, whereby the front and back of the medium are reversed. The printing device 1 ejects the ink from the printing section 20 onto the medium located in the support section 25 while conveying the medium from upstream to downstream and performs printing on the second surface of the medium. Accordingly, printing is executed on both the surfaces of the medium. In the case of the roll paper RP obtained by unwrapping the medium from a roll state, printing on the back surface is executed on the medium cut into a single sheet paper state by the cutting section 27 after the printing on the front surface.

A roll paper storing section 40 is provided on the inside of the housing 2. The roll paper storing section 40 includes a first medium holding section 42 that holds the roll paper RP in a roll body state. The roll paper RP is rotatably supported via a support shaft 41 extending in the X direction of the housing 2. That is, the roll paper RP is rotatably supported by the roll paper storing section 40 together with the support shaft 41 with the support shaft 41 as a rotation center. The support shaft 41 is configured to be rotatable in both of a forward rotation direction and a reverse rotation direction. In the roll paper storing section 40, a roll paper conveyance path 50 that conveys the roll paper RP unwound from the roll state is provided at a position facing a support member 43. The roll paper conveyance path 50 configures the roll paper supply path 30R.

The roll paper conveyance path 50 includes a first roller pair 51, a second roller pair 52, a third roller pair 53, and a curved surface section 54. The first roller pair 51 includes a driving roller 51a driven by a motor and a driven roller 51b facing the driving roller 51a and driven to rotate as the driving roller 51a rotates. The second roller pair 52 includes a driving roller 52a driven by a motor and a driven roller 52b facing the driving roller 52a and driven to rotate as the driving roller 52a rotates. The third roller pair 53 includes a driving roller 53a driven by a motor and a driven roller 53b facing the driving roller 53a and driven to rotate as the driving roller 53a rotates. The curved surface section 54 has a curved surface 54a on which the conveyed medium slides. In the roll paper conveyance path 50, the first roller pair 51, the second roller pair 52, and the third roller pair 53 are driven to rotate forward, whereby the medium is conveyed from upstream to downstream in the conveyance direction A, that is, the forward direction while being pressed against the curved surface 54a of the curved surface section 54.

The single sheet paper storing section 60 is provided on the inside of the housing 2. The single sheet paper storing section 60 includes a box-shaped tray 61 in which the single sheet paper SP, which is a single sheet medium, is stored. The tray 61 includes a pair of edge guides 65 operated when positioning the single sheet paper SP in the width direction, a stopper 64 operated when positioning the single sheet paper SP in the front-rear direction, and a placement surface 63 on which a downstream end portion of the single sheet paper SP stored in the tray 61 faces the pickup roller 72.

The single sheet paper storing section 60 forms a part of a single sheet paper supply unit 70 that supplies the single sheet paper SP toward the printing section 20. The single sheet paper supply unit 70 includes the single sheet paper storing section 60 including the placement surface 63 serving as a placement section on which a plurality of pieces of single sheet paper SP can be placed, a single sheet paper conveyance path 71, a pickup roller 72, a retard roller 73, a separation roller 74, serving as feeding rollers that are provided at a position facing the single sheet paper storing section 60 and feed the single sheet paper SP placed on the single sheet paper storing section 60 in the conveyance direction A from the single sheet paper storing section 60 toward the printing section 20, a separation member 76, and the like.

The single sheet paper conveyance path 71 is bent upward from the separation roller 74 and the retard roller 73 and configures the single sheet paper supply path 30S. In the single sheet paper conveyance path 71, a single sheet paper conveyance roller pair 75 that applies a conveyance force to the single sheet paper SP is provided at an appropriate interval. The single sheet paper SP is conveyed by rotationally driving the single sheet paper conveyance roller pair 75.

As explained above, the printing device 1 in the present embodiment includes the conveyance section 31 that conveys the medium in the conveyance direction A along the conveyance path 30 and the printing section 20 that ejects droplets onto the medium conveyed in the conveyance path 30 to perform printing. The roll paper supply path 30R includes the curved surface section 54 having the curved surface 54a, the first roller pair 51, the second roller pair 52, and the third roller pair 53.

Here, the second roller pair 52 conveys the medium in the conveyance path 30 while pressing the medium against the curved surface 54a of the curved surface section 54. When the conveyance is continuously stopped in a state in which the medium is pressed against the curved surface 54a of the curved surface section 54, a curl (a curved crease) convex downward along the curved surface 54a sometimes occurs. Thus, the second roller pair 52 is configured to be capable of conveying the medium in a state of being curled to be convex upward in a direction opposite to the curved surface 54a.

In other words, the printing device 1 in the present embodiment includes the curved surface section 54 serving as a wrapping section provided in the conveyance path 30, the medium being able to be wound thereon, and the second roller pair 52 serving as a de-curl roller pair located further downstream than the curved surface section 54 in the conveyance direction A and capable of performing a de-curl operation of nipping and bending, in a correcting direction, a curled portion that has occurred in the medium by being wound on the curved surface section 54. Furthermore, as illustrated in FIG. 1, the printing device 1 in the present embodiment includes a control section 80. The control section 80 can control the second roller pair 52 to execute the de-curl operation and can control the conveyance of the medium by the conveyance section 31.

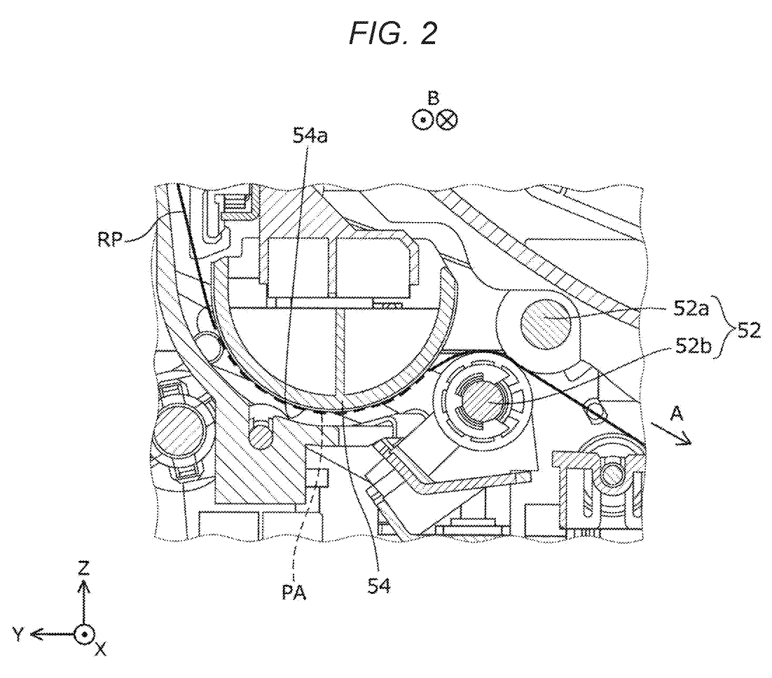

Details of the de-curl operation, which is an example of a printing method performed using the printing device 1 in the present embodiment, is explained below with reference to FIGS. 2 to 4. The de-curl operation performed using the printing device 1 in the present embodiment is an operation carried out by the control section 80 controlling constituent members of the printing device 1 in the present embodiment and is an operation carried out when the conveyance is stopped for the first predetermined time or more in a state in which the medium is wound on the curved surface 54a of the curved surface section 54.

In the de-curl operation performed using the printing device 1 in the present embodiment, in step S110, the control section 80 counts an elapsed time from a medium conveyance operation performed last. Then, when receiving, in step S120, an instruction command from a user involving conveyance of the medium such as an instruction of a printing operation, the control section 80 determines in step S130 whether the elapsed time counted in step S110 has exceeded a first predetermined time (for example, eight hours). When the control section 80 determines in step S130 that the elapsed time has exceeded the first predetermined time, the processing proceeds to step S140 and, when the control section 80 determines in step S130 that the elapsed time has not exceeded the first predetermined time, the processing proceeds to step S150.

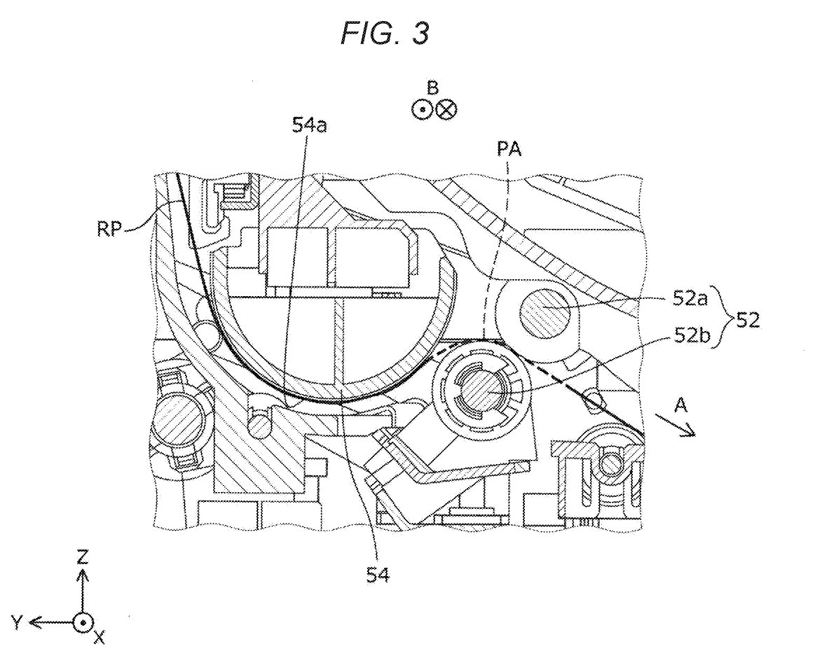

When the processing proceeds from step S130 to step S140, the control section 80 conveys the medium by a predetermined amount in step S140. Thereafter, the control section 80 stops the conveyance for a second predetermined time (for example, twenty seconds) in step S160 and maintains that state. Specifically, before the execution of step S140, for example, when the elapsed time counted in step S110 is longer than the first predetermined time, as indicated by a broken line in FIG. 2, a curl (a curved crease) convex downward along the curved surface 54a has sometimes occurred in the region PA of the medium (the roll paper RP) by being wound on the curved surface section 54. Thus, in step S140, the control section 80 conveys the medium by a predetermined amount. As illustrated in FIG. 3, the control section 80 conveys the region PA to a nip position by the second roller pair 52. Then, in step S160, the control section 80 maintains that state for the second predetermined time.

At the nip position by the second roller pair 52, as illustrated in FIG. 3, the region PA is wound on the driven roller 52b of the second roller pair 52 to be maintained in a state of being convex upward. By performing the operation explained above in step S140 and step S160, when a curl of the region PA being convex downward has occurred by being wound on the curved surface section 54, it is possible to de-curl such a curl (eliminate the curl). After the execution of step S160, according to an instruction command from the user involving the conveyance of the medium such as the instruction for the printing operation in step S120, the control section 80 conveys the medium in step S170 and ends the de-curl operation performed using the printing device 1 in the present embodiment.

On the other hand, when the processing proceeds from step S130 to step S150, the control section 80 resets the elapsed time and the processing proceeds to step S170. Then, according to an instruction command from the user involving the conveyance of the medium such as the instruction of the printing operation in step S120, the control section 80 conveys the medium in step S170 and ends the de-curl operation performed using the printing device 1 in the present embodiment.

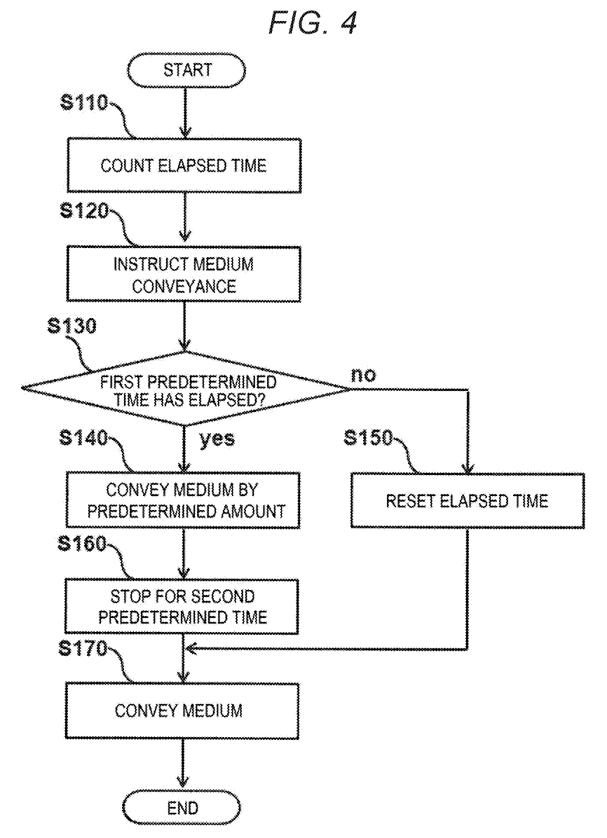

As explained above, in the de-curl operation performed using the printing device 1 in the present embodiment illustrated in FIG. 4, in step S140, according to the control of the control section 80, the medium is conveyed until the curled portion (the region PA) reaches the second roller pair 52 serving as the de-curl roller pair. Then, in step S160, the control section 80 stops the conveyance for the second predetermined time in a state in which the curled portion (the region PA) is nipped by the second roller pair 52. In step S170, the control section 80 conveys the medium toward the printing section 20.

By performing the de-curl operation explained above, it is possible to reduce a conveyance amount of the medium involved in the de-curl operation and it is possible to carry out the de-curl operation in a short time. By appropriately setting the first predetermined time and the second predetermined time, it is possible to correct the curved crease while preventing a new curved crease curling in the opposite direction in the curled portion (the region PA) from occurring. That is, it is possible to suitably de-curl the curled portion (the region PA) that has occurred in the medium.

Furthermore, by performing the de-curl operation explained above, it is possible to reduce a risk such as a jam of the medium or damage to the medium that can occur when the medium is conveyed through the conveyance path 30. It is possible to reduce a time required for the de-curl and it is possible to reduce a time required until printing. It is possible to prevent the leading end of the medium from being discharged to, for example, the outside of the housing 2 and it is possible to prevent the user from touching the medium discharged to the outside of the housing 2. Furthermore, by physically bending the medium in a direction opposite to the direction in which the curved crease has occurred, it is possible to enhance the effect of eliminating the de-curl.

In the de-curl operation performed using the printing device 1 in the present embodiment illustrated in FIG. 4, in step S110, according to the control of the control section 80, the elapsed time from the stop of the conveyance of the medium is counted every time the conveyance of the medium is stopped. When determining in step S130 that the medium has been conveyed after the elapsed time has exceeded the first predetermined time, in steps S140 and S160, the control section 80 carries out the de-curl operation at the time of the conveyance performed after the first predetermined time corresponding to step S170 has elapsed. On the other hand, when determining in step S130 that the medium has been conveyed before the elapsed time exceeds the first predetermined time, the control section 80 does not carry out the de-curl operation at the time of the conveyance corresponding to steps S140 and S160 and resets the elapsed time in step S150. By performing the de-curl operation explained above, it is possible to suitably correct the curved crease while preventing a new curved crease curling in the opposite direction in the curled portion (the region PA) from occurring.

Here, in the printing device 1 in the present embodiment, the control section 80 is capable of receiving input of information such as a type of a medium in use from the user via a not-illustrated computer or the like. According to the information such as the medium in use, the printing device 1 in the present embodiment is capable of changing the first predetermined time in step S130 and the second predetermined time in step S160 according to at least one of the rigidity and the thickness of the medium.

By performing the de-curl operation explained above, it is possible to particularly suitably de-curl, according to at least one of the rigidity and the thickness of the medium, the curled portion (the region PA) that has occurred in the medium. Specifically, when the thickness of the medium increases or the rigidity of the medium increases, it is possible to adopt at least one of reducing the first predetermined time and increasing the second predetermined time and, when the thickness of the medium decreases or the rigidity of the medium decreases, it is possible to adopt at least one of increasing the first predetermined time and reducing the second predetermined time.

Furthermore, the printing device 1 in the present embodiment includes a not-illustrated thermometer and a not-illustrated hygrometer. The control section 80 is capable of receiving information concerning ambient temperature and ambient humidity measured by the thermometer and the hygrometer. The printing device 1 in the present embodiment is capable of changing the first predetermined time and the second predetermined time according to at least one of the ambient temperature and the ambient humidity. Instead of not providing the thermometer or the hygrometer, the control section 80 may be configured to be capable of receiving input of information such as ambient temperature and ambient humidity from the user via a not-illustrated computer or the like.

By performing the de-curl operation explained above, it is possible to particularly suitably de-curl, according to at least one of the ambient temperature and the ambient humidity, the curled portion (the region PA) that has occurred in the medium. Specifically, since the medium tends to be hard when the ambient temperature or the ambient humidity drops, it is possible to adopt at least one of reducing the first predetermined time and increasing the second predetermined time. Since the medium tends to be soft when the ambient temperature or the ambient humidity rises, it is possible to adopt at least one of increasing the first predetermined time and reducing the second predetermined time.

Here, as explained above, the second predetermined time can be set to, for example, twenty seconds and the first predetermined time can be set to, for example, eight hours. As explained above, the second predetermined time is preferably shorter than the first predetermined time. This is because, by performing the de-curl operation explained above, it is possible to reduce the time required for the de-curl and it is possible to suitably correct the curved crease while preventing a new curved crease curling in the opposite direction in the curled portion (the region PA) from occurring.

However, the printing device 1 in the present embodiment is capable of changing the second predetermined time according to a time in which the conveyance is stopped in a state in which the medium is wound on the curved surface section 54 serving as the wrapping section. By making it possible to change the second predetermined time according to the time in which the conveyance is stopped in the state in which the medium is wound on the curved surface section 54 serving as the wrapping section, it is possible to suitably correct the curved crease while suppressing a new curved crease curling in the opposite direction in the curled portion (the region PA) from occurring.

Furthermore, when, according to the control of the control section 80, the medium is conveyed until the curled portion (the region PA) reaches the second roller pair 52 in step S140, the printing device 1 in the present embodiment can execute the following operation. First, in a state in which the second roller pair 52 nips the medium, the medium is conveyed by a predetermined amount in the conveyance direction A such that the curled portion (the region PA) passes through the second roller pair 52. Subsequently, the medium is conveyed in a reverse conveyance direction, which is a direction opposite to the conveyance direction A, to a position where the curled portion (the region PA) is nipped by the second roller pair 52. Finally, the curled portion (the region PA) is brought into a state of being nipped by the second roller pair 52.

That is, in the printing device 1 in the present embodiment, the curled portion (the region PA) passes through the second roller pair 52, which is the de-curl roller pair, to ease the curved crease and then is nipped again by the second roller pair 52 to be de-curled. By performing such an operation, it is possible to reduce the second predetermined time. Here, the predetermined amount is an amount by which the entire curled portion (region PA) only has to pass through the second roller pair 52, which is the de-curl roller pair, and is preferably not set too long.

The present disclosure is not limited to the embodiment explained above and can be implemented in various configurations without departing from the gist of the present disclosure. In order to solve some or all of the problems described above or to achieve some or all of the effects described above, the technical features in the embodiment corresponding to the technical features in the respective aspects described in the summary can be substituted or combined as appropriate. The technical features can be eliminated as appropriate unless being explained as essential technical features in the present specification.

What is claimed is:

1. A printing device comprising:
a conveyance section configured to convey a medium in a conveyance direction along a conveyance path;
a printing section configured to eject droplets onto the medium to perform printing;
a wrapping section provided on the conveyance path, the medium being wound on the wrapping section;
a de-curl roller pair located further downstream than the wrapping section in the conveyance direction and configured to perform a de-curl operation of nipping a curled portion caused in the medium when the medium is wound on the wrapping section and bending the curled portion in a correcting direction; and
a control section configured to control the de-curl operation to be executable and control the conveyance of the medium by the conveyance section, wherein
the de-curl operation is an operation carried out when the conveyance is stopped for a first predetermined time or more in a state in which the medium is wound on the wrapping section, and
the control section conveys the medium until the curled portion reaches the de-curl roller pair and conveys the medium toward the printing section after stopping the conveyance for a second predetermined time in a state in which the curled portion is nipped by the de-curl roller pair.

2. The printing device according to claim 1, wherein, every time the conveyance of the medium is stopped, the control section counts an elapsed time after the conveyance of the medium was stopped, when the medium was conveyed after the elapsed time exceeded the first predetermined time, carries out the de-curl operation at a time of conveyance performed after the first predetermined time elapsed, and, when the medium was conveyed before the elapsed time exceeds the first predetermined time, does not carry out the de-curl operation at the time of the conveyance and resets the elapsed time.

3. The printing device according to claim 1, wherein the first predetermined time and the second predetermined time are changeable according to at least one of rigidity and thickness of the medium.

4. The printing device according to claim 1, wherein the first predetermined time and the second predetermined time are changeable according to at least one of ambient temperature and ambient humidity.

5. The printing device according to claim 1, wherein the second predetermined time is shorter than the first predetermined time.

6. The printing device according to claim 1, wherein the second predetermined time is changeable according to a time in which the conveyance is stopped in a state in which the medium is wound on the wrapping section.

7. The printing device according to claim 1, wherein, when conveying the medium until the curled portion reaches the de-curl roller pair, the control section conveys the medium by a predetermined amount in the conveyance direction such that the curled portion passes through the de-curl roller pair in a state in which the de-curl roller pair nips the medium and conveys the medium in a reverse conveyance direction, which is a direction opposite to the conveyance direction, to a position where the curled portion is nipped by the de-curl roller pair and brings the curled portion into a state of being nipped by the de-curl roller pair.

8. A printing method performed by a printing device including:
a conveyance section configured to convey a medium in a conveyance direction along a conveyance path;
a printing section configured to eject droplets onto the medium to perform printing;
a wrapping section provided on the conveyance path, the medium being wound on the wrapping section; and
a de-curl roller pair located further downstream than the wrapping section in the conveyance direction and configured to perform a de-curl operation of nipping a curled portion caused in the medium when the medium is wound on the wrapping section and bending the curled portion in a correcting direction,
the de-curl operation being an operation carried out when the conveyance is stopped for a first predetermined time or more in a state in which the medium is wound on the wrapping section,
the printing method comprising:
conveying the medium until the curled portion reaches the de-curl roller pair; and
conveying the medium toward the printing section after stopping the conveyance for a second predetermined time in a state in which the curled portion is nipped by the de-curl roller pair.

9. The printing method according to claim 8, further comprising:
every time the conveyance of the medium is stopped, counting an elapsed time after the conveyance of the medium was stopped;
when the medium was conveyed after the elapsed time exceeded the first predetermined time, carrying out the de-curl operation at a time of conveyance performed after the first predetermined time elapsed; and
when the medium was conveyed before the elapsed time exceeds the first predetermined time, not carrying out the de-curl operation at the time of the conveyance and resetting the elapsed time.

10. The printing method according to claim 8, wherein the first predetermined time and the second predetermined time are changed according to at least one of rigidity and thickness of the medium.

11. The printing method according to claim 8, wherein the first predetermined time and the second predetermined time are changed according to at least one of ambient temperature and ambient humidity.

12. The printing method according to claim 8, wherein the second predetermined time is shorter than the first predetermined time.

13. The printing method according to claim 8, wherein the second predetermined time is changed according to a time in which the conveyance is stopped in a state in which the medium is wound on the wrapping section.

14. The printing method according to claim 8, wherein
when conveying the medium until the curled portion reaches the de-curl roller pair,
the medium is conveyed by a predetermined amount in the conveyance direction such that the curled portion passes through the de-curl roller pair in a state in which the de-curl roller pair nips the medium;
the medium is conveyed in a reverse conveyance direction, which is a direction opposite to the conveyance direction, to a position where the curled portion is nipped by the de-curl roller pair; and
the curled portion is brought into a state of being nipped by the de-curl roller pair.
